(19) United States
(12) Patent Application Publication
(10) Pub. No.: US 2007/0000448 A1
(43) Pub. Date: Jan. 4, 2007

(54) Multiple function animal furniture system

(76) Inventor: Dan Dietz, Houston, TX (US)

Correspondence Address: TUMEY, L.L.P., P.O. BOX 22188, HOUSTON, TX, 77227-2188, US

(21) Appl. No.: 11/455,489

(22) Filed: Jun. 19, 2006

Related U.S. Application Data
(63) Continuation-in-part of application No. 11/438,040, filed on May 19, 2006.
Application No. 11/438,040 is a continuation-in-part of application No. 11/287,716, filed on Nov. 28, 2005.
Application No. 11/287,716 is a continuation-in-part of application No. 11/121,797, filed on May 4, 2005.

(51) Int. Cl. A01K 1/03

(52) U.S. Cl. 119/481

(57) ABSTRACT

An animal housing is disclosed. In an embodiment, the animal housing comprises a cage having at least one cage side comprising a door. The door is movably attached to a cage side of the cage. In addition, the door is openable to provide an opening in the side of sufficient size to allow a desirable animal to pass therethrough. The animal housing further comprises an outer covering comprising a plurality of outer covering sides, wherein the outer covering comprises a first outer covering side secured to a second outer covering side by a magnet.

### CROSS-REFERENCE TO RELATED APPLICATIONS

This application is a continuation-in-part application of U.S. application Ser. No. 11/438,040 filed on May 19, 2006, which is a continuation-in-part application of U.S. application Ser. No. 11/287,716 filed on Nov. 28, 2005, which is a continuation-in-part application of U.S. application Ser. No. 11/121,797 filed on May 4, 2005, which are each herein incorporated by reference in their entirety.

### STATEMENT REGARDING FEDERALLY SPONSORED

### RESEARCH OR DEVELOPMENT

Not applicable.

### BACKGROUND OF THE INVENTION

1. Field of the Invention

This invention relates to furniture for an animal and in particular to a piece of furniture that has multiple configurations and can function in multiple ways to accommodate various desires of the animal at any stage of growth. More particularly, this furniture structure and system may function as a living quarters for smaller animals such as puppies during house training periods, a storage location for objects related to the animal, as an animal bed, a sitting bench for humans or animals, and/or as an animal step for getting into a human bed.

2. Background of the Invention

For many people, pet animals are members of the family. Some of these pets live inside the home with the owner and have many accessories designed especially for the animal. As with the “dog houses” kept in the yard, some of the furnishings provide a place for the animal to dwell as well as providing a storage place for the toys of the animal. One conventional piece of animal furniture is a bed. There have been many types of animal beds. These beds are available in various designs. Some of the designs include beds shaped as different types of animals. Many beds in the form of animal designs are made of a cushion material to facilitate animal comfort.

One animal bed is disclosed in U.S. Pat. No. 5,662,065 and describes an animal bed that includes an annular bed frame defining an interior chamber. A perforated top wall is supported at its periphery by the bed frame to receive and support the animal above the chamber. The perforated top wall is composed of a non-woven fabric material to provide a hammock-like suspension for the animal and to permit small insects to fall through the top wall. The chamber is dimensioned to provide a space below the top wall sufficient to inhibit the insects from traveling upwardly through the top wall. An insect exterminating composition contained within the chamber receives the falling insects and destroys them.

U.S. Patent d 288,970 describes a combined animal bed and housing unit. This design has a bed mat resting on a storage unit. The bed also has a canopy covering the mat. The animal would rest on the mat and would be covered by the canopy.

Although the animal bed is a common piece of furniture for the inside pet, animals do more than just sleep. For instance, cats usually have a litter box for waste. Many pets and owners have a system by which the pet is let out of the house on a periodic basis to relieve themselves. Pets also have toys with which they play. One particular thing some pets like to do is to climb up on the owner's bed. The climbing is necessary because many pets cannot jump high enough to reach the surface of the bed in one jump. The climbing process results in the pet pulling and sometimes tearing the bed linen. Pets also do not stay the same size. As the pet grows, it is often necessary to replace a piece of animal furniture with a different type of furniture or a larger size of the same furniture.

With all of the different types of animal furniture that is available to accommodate the many needs of the pet and pet owner, there remains a need for a multiple function piece of animal furniture.

### BRIEF SUMMARY OF SOME OF THE PREFERRED EMBODIMENTS

These and other needs in the art are addressed in one embodiment by an animal housing. The animal housing comprises a cage having at least one cage side comprising a door. The door is movably attached to a cage side of the cage. In addition, the door is openable to provide an opening in the side of sufficient size to allow a desirable animal to pass therethrough. The animal housing further comprises an outer covering comprising a plurality of outer covering sides. The outer covering comprises a first outer covering side secured to a second outer covering side by a magnet.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a front, top and side view of the multiple function animal furniture piece;

FIG. 2 illustrates a view of the multiple function animal furniture piece with the top extended up to open the furniture piece;

FIG. 3 illustrates a view of the multiple function animal furniture piece with a ramp member extended from the furniture piece;

FIG. 4 illustrates an illustration of the multiple function animal furniture piece with a cushion material positioned on the top on which an animal may rest or sleep;

FIG. 5 illustrates a frontal side view of the ramp member;

FIG. 6 illustrates a side cross-section view of the ramp member showing a lip used to enable the ramp member to engage the furniture piece;

FIG. 7 illustrates a view down on the floor mat positioned on the furniture piece;

FIG. 8 illustrates a side cross-section view of the floor mat;

FIG. 9 illustrates a cross-section view of the cushion material positioned on the top of the furniture piece;

FIG. 10 illustrates a view of the back side of the furniture piece showing a rack means used to store a grate or screen;

FIG. 11 illustrates a design of a detachable grate used to cover the front opening of the furniture piece;

FIG. 12 illustrates a cross-section view of the guide used for storing the grate;

FIG. 13 illustrates a front view of a multiple function animal furniture piece showing a front and top side and having a cage and an outer covering;

FIG. 14(a) illustrates an embodiment of a side of the outer covering;

FIG. 14(b) illustrates an embodiment of a side of the outer covering;

FIG. 15 illustrates an embodiment showing a cage and an outer covering with the top side of the outer covering removed;

FIG. 16 illustrates a multiple function animal furniture piece comprising a cage; and

FIG. 17 illustrates an embodiment of the multiple function animal furniture piece of FIG. 13 with a door in an open position.

### DETAILED DESCRIPTION OF THE PREFERRED EMBODIMENTS

The multiple function animal furniture piece provides an animal owner with a system they may use for an animal throughout the life of the animal. The multiple function animal furniture piece may serve as a training cage to help train small animals such as puppies for living indoors. A detachable mat on the floor of the multiple function animal furniture piece provides for ease in cleaning animal waste. A removable front cover such as a grill or grate may serve to restrict undesired movement of the animal in and out of the furniture piece. As an animal gets older and/or bigger, the animal may no longer dwell inside the multiple function animal furniture piece. At this point, the multiple function animal furniture piece may have another function as a store structure. The multiple function animal furniture piece may have an attachable ramp member for use by an animal to climb to the top of the multiple function animal furniture piece structure. This ramp is especially useful for smaller animals and older animals. The ramp may be stored inside the multiple function animal furniture piece when the ramp is not in use. The multiple function animal furniture piece is portable and may be positioned adjacent the owner's bed. In this arrangement, the animal may easily move to the owner's bed. Further, the owner may easily sit on the top of the multiple function animal furniture piece. When an animal dies, the structure may be converted into a container (e.g., coffin) for burying the deceased animal.

FIG. 1 shows a general design of the multiple function animal furniture piece 5. Other configurations such as those described in U.S. patent application Ser. No. 11/121,797 to the same inventor may be implemented to achieve the same results as the design described in FIG. 1. As shown, multiple function animal furniture piece 5 has a top 10, open front side 12, a back side 14, and multiple side walls 16 and 18. The number of sides may vary with the particular design shape. Multiple function animal furniture piece 5 may also contain a floor 20. The front side 12 has an opening 22, which covers a large portion of the front side 12. This large opening 22 allows for animals to enter multiple function animal furniture piece 5. Without limitation, the opening 22 also allows for insertion of toys, food and water trays into the multiple function animal furniture piece 5. In addition, smaller openings 24 and 26 may be disposed in the side walls 16, 18. Without limitation, these openings 24, 26 may improve ventilation in multiple function animal furniture piece 5. The front side 12 also has a lip 28 that extends up from the base. Without limitation, lip 28 serves to prevent toys such as balls from accidentally rolling out of the multiple function animal furniture piece 5. In addition, a lip section (not illustrated) may also be attached to the top 10. Without limitation, this lip section may serve as restraining means to stabilize the cushion and keep the cushion stationary when an animal is resting on it.

Multiple function animal furniture piece 5 may be composed of any material suitable for the uses of multiple function animal furniture piece 5. For instance, multiple function animal furniture piece 5 may include wood, mesh, wire, plastic, metal, and the like. In an embodiment, back side 14 and/or multiple side walls 16 and 18 may be composed of a plurality of openings in addition to openings 24, 26. The additional openings may be of any desired shape and configuration. In such an embodiment, back side 14 and/or multiple side walls 16 and 18 may comprise wire, mesh, netting, weaving, and the like, preferably wire or mesh, and more preferably wire or wire-like material. Moreover, back side 14 and/or multiple side walls 16 and 18 may be composed of any porous material suitable for use as a side in an animal cage (e.g., porous metal or plastic siding). In an embodiment, back side 14 and/or multiple side walls 16 and 18 are composed of a plastic, wood, metal, or the like wire or wire-like material. One or more of multiple side walls 16 and 18 (preferably all) may be composed of such materials. In an embodiment (not illustrated), an outer covering may be disposed on the outside and/or inside surface of one or more of back side 14 and/or multiple side walls 16 and 18, preferably an outer covering is disposed on the outside surface. In some embodiments, an outer covering is disposed on the outside surface of multiple side walls 16 and 18 and back side 14. The outer covering may cover any desired portion of a side. The outer covering may comprise any suitable covering for use with animals. For instance, the outer covering may be composed of natural or synthetic woods, veneers, vinyl, wicker, plastic, ceramic, and the like. In an embodiment, top 10 and/or front side 12 may also be composed of such plurality of openings and alternatively may also include such an outer covering. In alternative embodiments, at least one side and/or wall of multiple function animal furniture piece 5 comprises a substantially solid material.

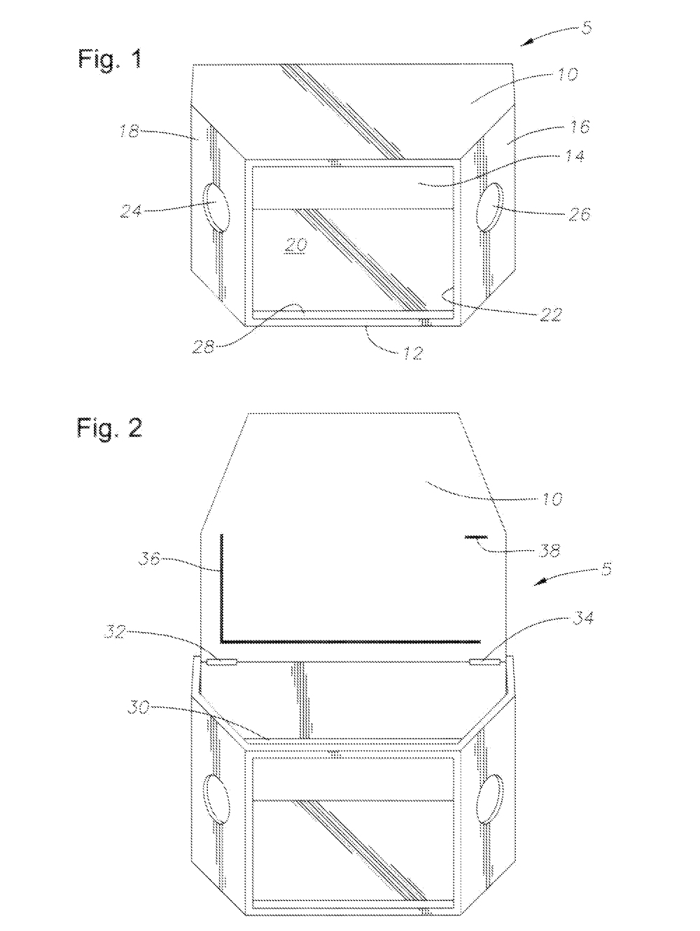

FIG. 2 shows the multiple function animal furniture piece 5 with the top 10 extended in an upward position, which thereby opens up multiple function animal furniture piece 5. As shown, a bar 30 extends across the front side of multiple function animal furniture piece 5 and serves as a rest bar for the top 10. Hinges 32 and 34 attach the top 10 to the back side 14 and allow the top 10 side to open and close as desired. Attached to the inside surface of the top 10 side is a rack member 36 for holding a ramp member when the ramp member is not in use. The rack may have any suitable shape (e.g., an L-shape) that fits with the shape of a rectangular ramp member. In an embodiment, the rack is a groove with a generally u-shape in which the ramp member is placed. When the ramp member is placed in the rack means, a latch 38 secures the ramp in the rack member.

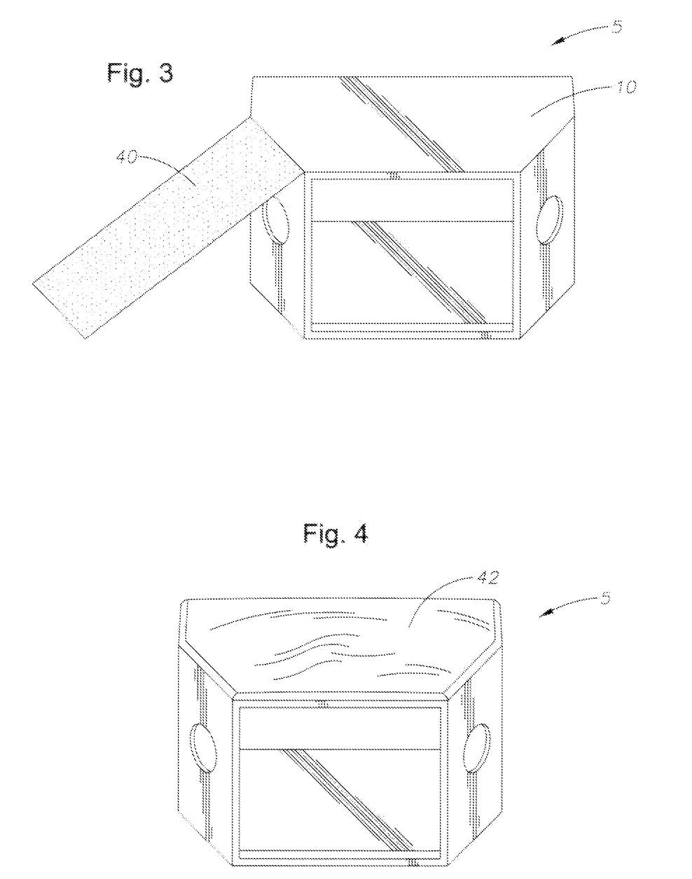

FIG. 3 shows a configuration of the multiple function animal furniture piece 5 with a detachable ramp 40 engaged at one side. In this configuration, an animal may climb to the top 10 of multiple function animal furniture piece 5 without the need to climb up on a bed or other piece of furniture. Depending on the height of multiple function animal furniture piece 5, the length of the ramp 40 may vary such that the inclination angle formed by the engagement of the ramp 40 to multiple function animal furniture piece 5 is not too steep for the animal to safely climb.

FIG. 4 shows the multiple function animal furniture piece 5 with the cushion material 42 positioned on the top 10. As mentioned, the cushion material 42 serves as a cushion on which an animal may rest or sleep. FIG. 9 shows the cross-section of a typical cushion that may be used with multiple function animal furniture piece 5. Other types of cushions with varying shapes may also be implemented in a similar manner.

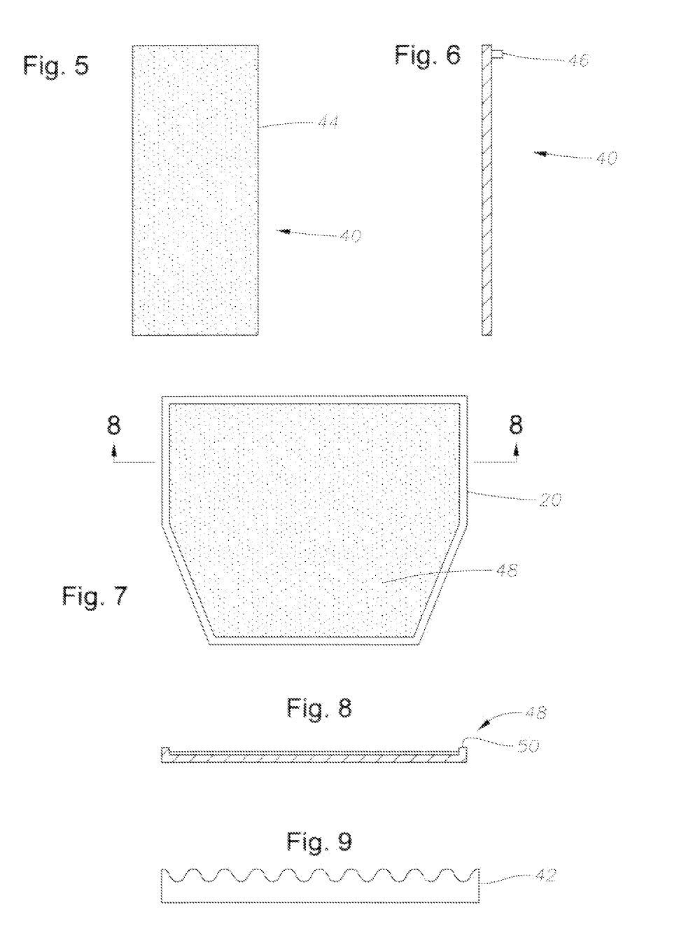

FIG. 5 shows a front view of the ramp member 40. Attached to this front side is a fiber-type material 44 such as a cloth or carpet material. Fiber-type material 44 increases the friction of the ramp member 40 such that an animal may have good traction as the animal climbs the ramp member 40 to the top 10. FIG. 6 shows a side cross-sectional view of the ramp member 40. The ramp member 40 contains a lip 46 that engages the edge of the top side securing the ramp member 40 to multiple function animal furniture piece 5.

FIG. 7 shows a view of the floor 20 of multiple function animal furniture piece 5 covered by a mat material 48. Mat material 48 may be an elastic or rubber type of material or other type of water-proof material. The mat material 48 extends up the side walls of multiple function animal furniture piece 5 thereby covering substantially all of the floor 20. This mat material 48 provides a way to easily clean multiple function animal furniture piece 5. As mentioned, multiple function animal furniture piece 5 may serve as a house for a smaller pet. Typically, these pets are initially not potty trained. Any waste secreted by the animal may not penetrate to the floor. When cleaning, the owner may raise the top 10 of multiple function animal furniture piece 5 and remove the mat material 48. The owner may then clean the mat material 48. FIG. 8 shows the cross-section of the mat material 48. The edge 50 of the mat 48 has a lip shape that prevents substances from escaping the mat material 48 surface. The mat material 48 may also have a ridged surface similar to FIG. 9 for channeling liquid.

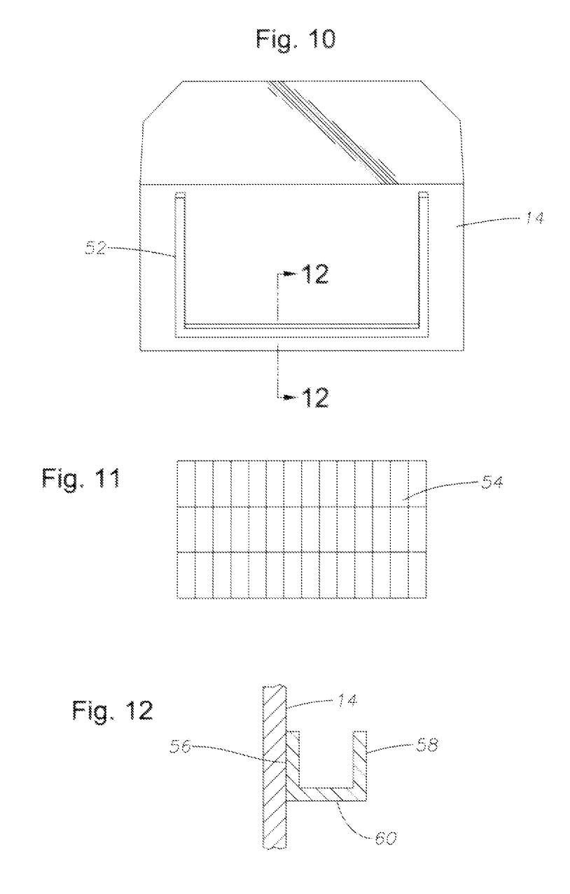

FIG. 10 shows the back side 14 of multiple function animal furniture piece 5. Attached to this back side 14 is a storage rack 52 similar to the rack member 36. Without limitation, storage rack 52 is for the purpose of holding grate 54 shown in FIG. 11. Storage rack 52 has a general shape that matches the shape of the grate 54. FIG. 12 shows a cross-section of the storage rack 52. Storage rack 52 has two sides 56 and 58 and a base 60. The two sides 56, 58 are perpendicularly attached to the base 60. One side is also attached to the back side 14. When the grate 54 is not in use, the owner may slide the grate 54 into the storage rack 52. The grate 54 may be used to cover the front opening 22. The grate 54 may have different designs and may also be composed of screen material. In addition, other conventional materials such as plastic may be used as this front opening 22 cover.

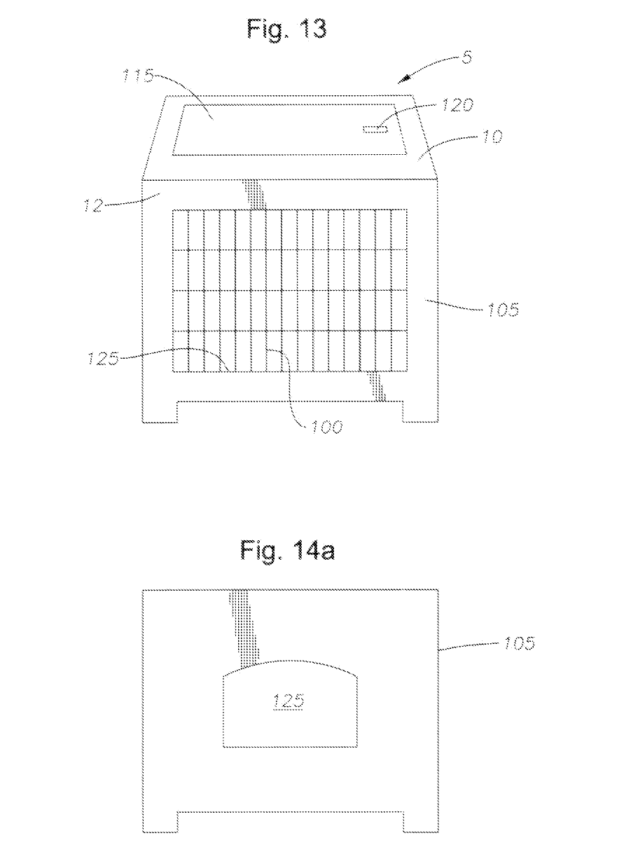

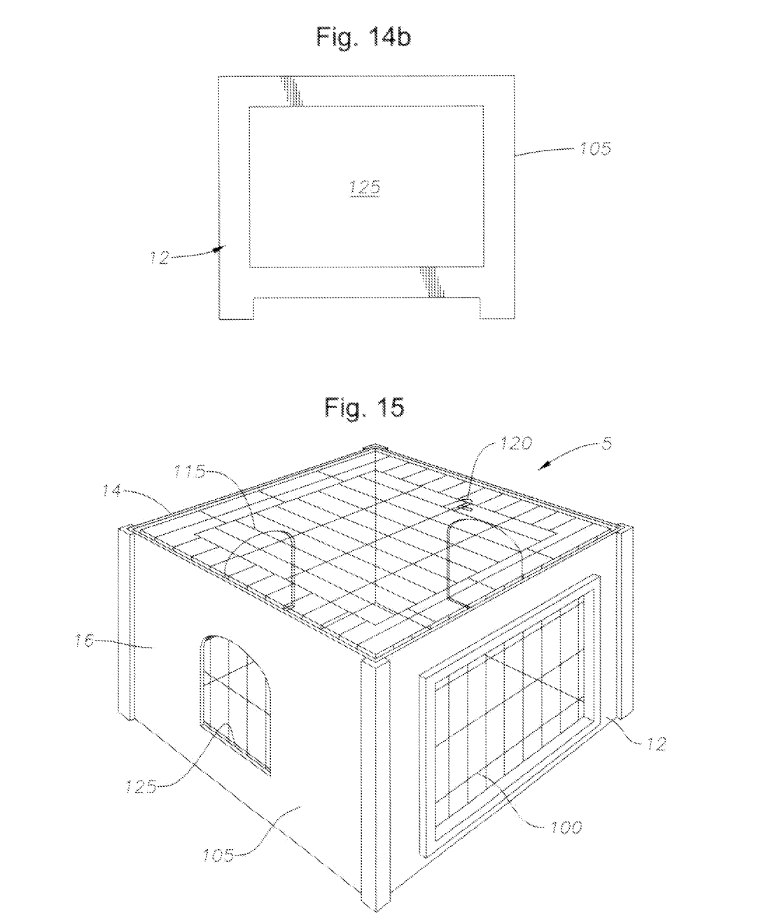

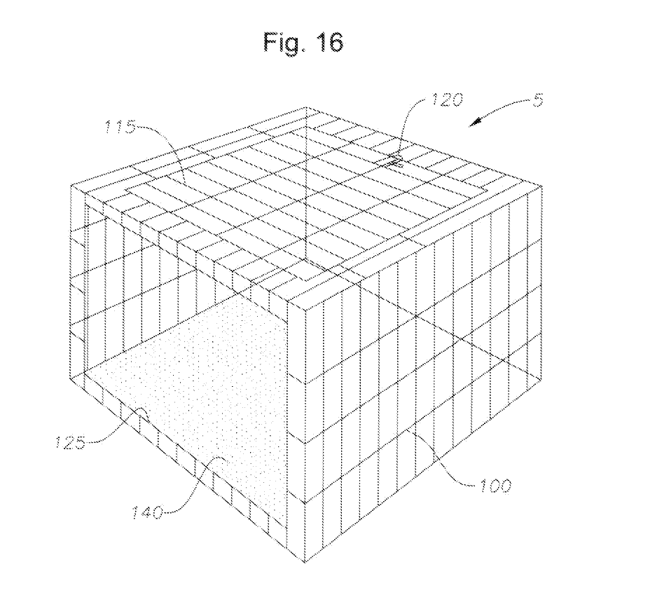

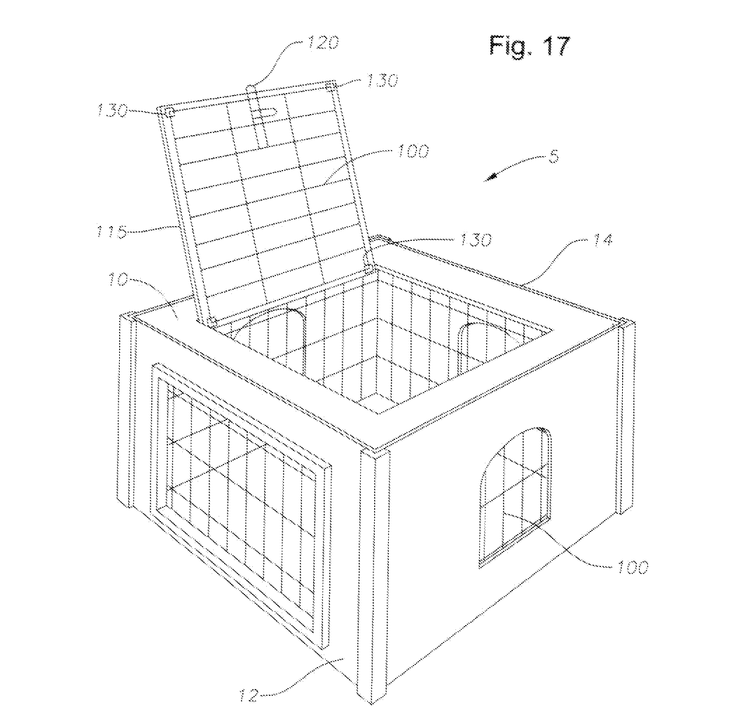

In an embodiment, multiple function animal furniture piece 5 comprises a cage and a outer covering on the top side 10, back side 14, front side 12, and sides 16, 18 of the cage. In an alternative embodiment, multiple function animal furniture piece 5 also comprises an outer covering on bottom side (e.g., floor 20). FIG. 13 illustrates a front view of such an embodiment showing front side 12 and top side 10. In such an embodiment, multiple function animal furniture piece 5 comprises a cage 100 and an outer covering 105. Cage 100 may comprise any suitable material for containing an animal. For instance, cage 100 may comprise metal, wood, plastic, ceramic, and the like. The sides of cage 100 may be attached by any suitable means. In an embodiment, top side 10 has a door 115 that is movably openable and closable. Door 115 comprises a latching mechanism 120 by which door 115 may be secured to top side 10 and substantially prevented from movement. Latching mechanism 120 may comprise any suitable mechanism for opening and closing door 115 and also suitable for securing door 115 against movement relative to top side 10. It is to be understood that FIG. 13 shows door 115 in a closed position. FIG. 17 illustrates an embodiment in which door 115 is in an open position. As shown in FIG. 13, outer covering 105 on front side 12 has opening 125 by which cage 100 is exposed therethrough. In an embodiment, at least one side of outer covering 105 has an opening; alternatively front side 12, sides 16, 18, and back side 14 of outer covering 105 has such openings; and alternatively all sides of outer covering 105 have an opening. FIGS. 14(a) and 14(b) show embodiments of sides of outer covering 105 having different opening configurations. For instance, FIG. 14(a) illustrates outer covering 105 having opening 125 therethrough. Outer covering 105 having such opening 125 may be suitable as side 16, side 18, and/or back side 14. It is to be understood that outer covering 105 may have more than one opening 125. Opening 125 may have any desirable shape and size. FIG. 14(b) illustrates an embodiment of front side 12 having outer covering 105 with opening 125. In such an embodiment, opening 125 may be of sufficient size to allow a desirable animal to pass therethrough. Further referring to FIG. 13, in an alternative embodiment, front side 12 of cage 100 may be movably attached to side 16 or 18 of cage 100. In such an embodiment, such front side 12 of cage 100 may be sufficiently movable to allow a desirable animal to pass through opening 125 in such front side 12. In such an alternative embodiment, such front side 12 of cage 100 may also be sufficiently closable to prevent the desirable animal from passing through opening 125 in front side 12. In alternative embodiment (not illustrated), another side is openable to allow a desirable animal to pass through an opening 125 therein into multiple functional animal furniture piece 5. In such an alternative embodiment, top side 10 may or may not be openable. For instance, FIG. 16 illustrates an embodiment of multiple functional animal furniture piece 5 comprising a cage 100 and no outer covering 105. As shown in FIG. 16, front side 12 has movably attached door 115 with a latching mechanism 120. It is to be understood that FIG. 16 shows door 115 in the open position and disposed on top of top side 12 thereby providing opening 125 in cage 100.

It is to be understood that outer covering 105 may be secured to cage 100 or not secured to cage 100. In an embodiment in which outer covering 105 is secured to cage 100, outer covering 105 may be secured by any suitable method. For instance, outer covering 105 may be secured to cage 100 by one or more grooves in outer covering 105. As an example, portions of cage 100 may be suitably secured into a groove disposed in outer covering 105.

FIG. 15 illustrates an embodiment of FIG. 13 with the outer covering 105 of top side 10 removed to expose top side 10 of cage 100. As shown, door 115 has latching mechanism 120.

The sides of outer covering 105 may be attached by any suitable method. For instance, the sides may be connected by magnets, glue, hooks, and the like. In an embodiment, the sides are connected by magnets. Each side of outer covering 105 may have any number of magnets suitable to sufficiently secure one such side to another such side (e.g., by magnetic attraction to another side). The magnets may be secured to the exterior of the outer covering 105 (e.g., by glue) and/or may be embedded in the outer covering 105. It is to be understood that each side of outer covering 105 may be separated from another side by applying sufficient force to overcome the force of the magnet. Thereby, one or more sides of outer covering 105 may be removed to expose cage 100. FIG. 16 illustrates an embodiment in which all sides of outer covering 105 have been removed. In an alternative embodiment, magnets disposed on the outer covering 105 may also be used to secure outer covering 105 to cage 100. For instance, FIG. 17 illustrates an embodiment in which magnets 130 on the outer covering 105 of door 115 secure such outer covering 105 of door 115 to the cage portion 105 of door 115. As shown in FIG. 16, multiple function animal furniture system 5 may also comprise a detachable mat 140.

As mentioned, the structure and system of the multiple function animal furniture piece 5 provides the owner of an animal with the versatile means for providing care for the animal. This structure and system may accommodate activities for animals of all ages and sizes. The structure serves as both a dwelling for small animals as well as a training cage to teach certain behaviors. The internal storage capacity makes this structure useful for any animal that has toys. The ability to store the detachable components of the system within the structure itself makes this system easy to manage. The portability of the structure enables the owner to position it at any location. As mentioned, owners can use it as a bed for the animal or as a means for the animal to climb into the owner's bed. The attachable ramp also makes it easy for animals of all ages and sizes to climb the ramp to the top side of the structure. At the animal's death, the structure may serve as a container coffin in which to bury the animal.

It is to be understood that sides 12, 14, 16, and 18 are for illustration and explanatory purposes and embodiments described for one of such particular sides may be suitable for one or more other of such sides.

Although the present invention and its advantages have been described in detail, it should be understood that various changes, substitutions and alterations may be made herein without departing from the spirit and scope of the invention as defined by the appended claims.

What is claimed is:

1. An animal housing, comprising:
a cage having at least one cage side comprising a door, wherein the door is movably attached to a cage side of the cage, and wherein the door is openable to provide an opening in the cage side of sufficient size to allow a desirable animal to pass therethrough; and
an outer covering comprising a plurality of outer covering sides, wherein the outer covering comprises a first outer covering side secured to a second outer covering side by a magnet.

2. The animal housing of claim 1, wherein the cage comprises metal, wood, ceramic, or plastic.

3. The animal housing of claim 1, wherein the cage comprises metal.

4. The animal housing of claim 1, further comprising more than one door.

5. The animal housing of claim 1, wherein the cage side having a door is a cage top side.

6. The animal housing of claim 1, wherein the door comprises a latching mechanism.

7. The animal housing of claim 1, wherein the cage side having a door is a cage front side.

8. The animal housing of claim 1, wherein the door is movably openable and closable.

9. The animal housing of claim 1, wherein at least one outer covering side comprises an outer covering opening.

10. The animal housing of claim 1, wherein each outer covering side comprises an outer covering opening.

11. The animal housing of claim 1, wherein the outer covering is secured to the cage.

12. The animal housing of claim 11, wherein the outer covering is secured to the cage by at least one magnet.

13. The animal housing of claim 11, wherein the outer covering is secured to the cage by at least one groove.

14. The animal housing of claim 1, wherein the magnet is secured to the outer covering.

15. The animal housing of claim 1, wherein the magnet is embedded in the outer covering.

16. The animal housing of claim 1, wherein the outer covering sides are detachable.

17. The animal housing of claim 1, wherein the cage sides are detachable.

18. The animal housing of claim 1, further comprising a detachable mat.

19. The animal housing of claim 1, wherein the outer covering comprises natural or synthetic wood, veneer, vinyl, wicker, plastic, or ceramic.

20. The animal housing of claim 1, wherein the outer covering comprises wood.
